(19) United States
(12) Patent Application Publication
(10) Pub. No.: US 2009/0244108 A1
(43) Pub. Date: Oct. 1, 2009

(54) METHOD AND APPARATUS TO DRIVE PLASMA DISPLAY DEVICE

(76) Inventor: Seung-Ho Park, Suwon-si (KR)

Correspondence Address: CHRISTIE, PARKER & HALE, LLP, PO BOX 7068, PASADENA, CA, 91109-7068, US

(21) Appl. No.: 12/406,010

(22) Filed: Mar. 17, 2009

(30) Foreign Application Priority Data
Mar. 25, 2008 (KR) 10-2008-0027300

(51) Int. Cl. G09G 5/10

(52) U.S. Cl. 345/690

(57) ABSTRACT

Method and apparatus for driving a plasma display device to improve a gradation display during the plasma display device is driven at a relatively high frame frequency. The driving method includes separating a unit frame of an input image signal into first and second subfield groups; and deciding a gradation of each of the subfield groups to display the gradation in a first frame frequency when a minimum gradation level of the first or second subfield group is equal to or below a first reference level, and to display the gradation in a second frame frequency when the minimum gradation level exceeds the first reference level.

### CROSS-REFERENCE TO RELATED APPLICATIONS

This application claims priority to and the benefit of Korean Patent Application No. 10-2008-0027300, filed on Mar. 25, 2008, in the Korean Intellectual Property Office, the entire content of which is incorporated herein by reference.

### BACKGROUND OF THE INVENTION

1. Field of the Invention

The present invention relates to a method and apparatus for driving a plasma display device.

2. Description of Related Art

A plasma display device is a flat panel display device for displaying letters or images by using plasma generated through a gas discharge. A plasma display device includes a display panel where hundreds of thousands to millions of pixels are arranged in a matrix depending on the size of the display panel. In the plasma display panel, scan electrodes and sustain electrodes are formed in parallel with each other on one side thereof, and on another side thereof, address electrodes are formed in a direction perpendicular to the scan and sustain electrodes. Each of the sustain electrodes forms a pair of electrodes with a corresponding one of the scan electrodes.

In a method of driving a typical plasma display device, one frame is divided into a plurality of subfields, and each subfield includes a reset period, an address period and a sustain period. The reset period is a period for resetting cells in order to perform an addressing operation in the cells without difficulty. The address period is for selecting turn-on and turn-off cells on the display panel and for setting up wall-charges in the turn-on cells. The sustain period is for performing a discharge to actually display an image by the cells that are turned on.

When a screen size of the plasma display device becomes large, and its resolution increases, higher numbers of pixels and electrodes coupled with the pixels are employed. In this case, a plasma display driving apparatus is required to drive the pixels through more electrodes during the same amount of time, and thus the driving apparatus needs to operate at a higher speed.

It is therefore desirable to develop a plasma display driving apparatus capable of providing a high frame frequency drive corresponding to a large-sized and high resolution plasma display device without lowering its image quality.

### SUMMARY OF THE INVENTION

Exemplary embodiments of the present invention provide a method of driving a plasma display device, which is capable of achieving a high frame frequency drive without deteriorating an image quality.

Embodiments of the present invention also provide an apparatus to drive a plasma display device by using the driving method described above.

According to an embodiment of the present invention, a method of driving a plasma display device includes separating a unit frame of an input image signal into first and second subfield groups; and deciding a gradation of each of the subfield groups to display the gradation in a first frame frequency when a minimum gradation level of the first or second subfield group is equal to or below a first reference level, and to display the gradation in a second frame frequency when the minimum gradation level exceeds the first reference level.

The first reference level may be a mean of the gradations of the first subfield and the second subfield that is consecutive to the first subfield. The first subfield has a minimum weighted value in a subfield group among the first and second subfield groups.

The first reference level may include a 1A reference level and a 1 B reference level different from the 1A reference level. The method of driving a plasma display device may include deciding a gradation of the respective subfield groups to display the gradation in a first frame frequency when a minimum gradation level of the first or second subfield group is equal to or below the 1A reference level, and to display the gradation in a pseudo second frame frequency when the minimum gradation level exceeds the 1A reference level and is equal to or below the 1B reference level, and to display the gradation in a second frame frequency when the minimum gradation level exceeds the 1B reference level.

The 1A reference level may be one half of the minimum gradation level. The 1B reference level may be a mean of the two minimum gradation levels of the first and second subfield groups, respectively.

The number of subfields in the first subfield group may be different from the number of subfields in the second subfield group.

The driving method may further include individually dithering the first and second subfield groups on the decided gradation.

The driving method may further include coding subfields in the respective first and second subfield groups on the decided gradation.

The driving method may further include combining coding information of the first subfield group and coding information of the second subfield group and generating final subfield information of the unit frame, and transferring the generated final subfield information to an address electrode driver.

The driving method may further include generating a drive signal for the decided gradation of the first and second subfield groups, and transferring the generated drive signal to a scan electrode driver and a sustain electrode driver.

The driving method may further include converting twice a frame frequency of the input image signal.

The first frame frequency may be 50 Hz or 60 Hz. The second frame frequency may be 100 Hz or 120 Hz.

According to another embodiment of the invention, an apparatus for driving a plasma display device includes a frame frequency converter for separating a unit frame of an input image signal into first and second subfield groups; and a gradation decision unit for deciding a gradation of the respective subfield groups to display the gradation in a first frame frequency when a minimum gradation level of the first or second subfield group transferred from the frame frequency converter is equal to or below a first reference level, and for displaying the gradation in a second frame frequency when the minimum gradation level exceeds the first reference level.

The first reference level may be a mean of the gradations of the first subfield and the second subfield that is consecutive to the first subfield. The first subfield has a minimum weighted value in a subfield group among the first and second subfield groups.

The first reference level may include a 1A reference level and a 1B reference level that is different from the 1A reference level. The gradation decision unit may decide a gradation of the respective subfield groups to display the gradation in the first frame frequency when a minimum gradation level of the first or second subfield group is equal to or below the 1A reference level, and to display the gradation in a pseudo second frame frequency when the minimum gradation level exceeds the 1A reference level and is equal to or below the 1B reference level, and to display the gradation in the second frame frequency when the minimum gradation level exceeds the 1B reference level.

The 1A reference level may be one half of a minimum gradation level. The 1B reference level may be a mean of the two minimum gradation levels of the first and second subfield groups.

The number of subfields in the first subfield group may be different from the number of subfields in the second subfield group.

The driving apparatus may further include a gradation processor for individually dithering the first and second subfield groups for the gradation decided in the gradation decision unit.

The driving apparatus may further include one pair of subfield coding units for coding subfields in the respective subfield groups received from the gradation processor.

The driving apparatus may further include a subfield coding combiner for combining coding information of the first subfield group and coding information of the second subfield group and generating final subfield information of a unit frame, and for transferring the generated final subfield information to an address electrode driver.

The driving apparatus may further include a drive controller for generating drive signals corresponding to the first and second subfield groups received from the gradation processor, transferring a portion of the generated drive signals to a scan electrode driver, and transferring another portion of the generated drive signals to a sustain electrode driver.

The frame frequency converter may convert twice a frame frequency of the input image signal. The first frame frequency may be 50 Hz or 60 Hz. The second frame frequency may be 100 Hz or 120 Hz.

According to the embodiments of the invention described above, a dual phase can be prevented from being generated on a moving image. In addition, a flicker problem or a non-uniform screen brightness can be solved or reduced. Furthermore a gradation display can be enhanced using a high frame frequency.

### BRIEF DESCRIPTION OF THE DRAWINGS

The accompanying drawings, together with the specification illustrate exemplary embodiments of the present invention, and, together with the description, serve to explain the principles of the present invention.

FIG. 1 is a block diagram of a plasma display device employing a driving method according to an embodiment of the present invention;

FIG. 2 illustrates a method of driving a plasma display device according to an embodiment of the present invention;

FIG. 3 illustrates a dithering result from a method of driving a plasma display device according to an embodiment of the present invention;

FIG. 4 illustrates a dithering result from a comparison example;

FIG. 5 illustrates a method of driving a plasma display device according to another embodiment of the present invention; and

FIG. 6 illustrates a method of driving a plasma display device as a comparison example.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be directly coupled to the second element, or may be indirectly coupled to the second element via a third element. Further, some of the elements that are not essential to the complete understanding of the present invention are omitted for clarity. Also, like reference numerals refer to like elements throughout.

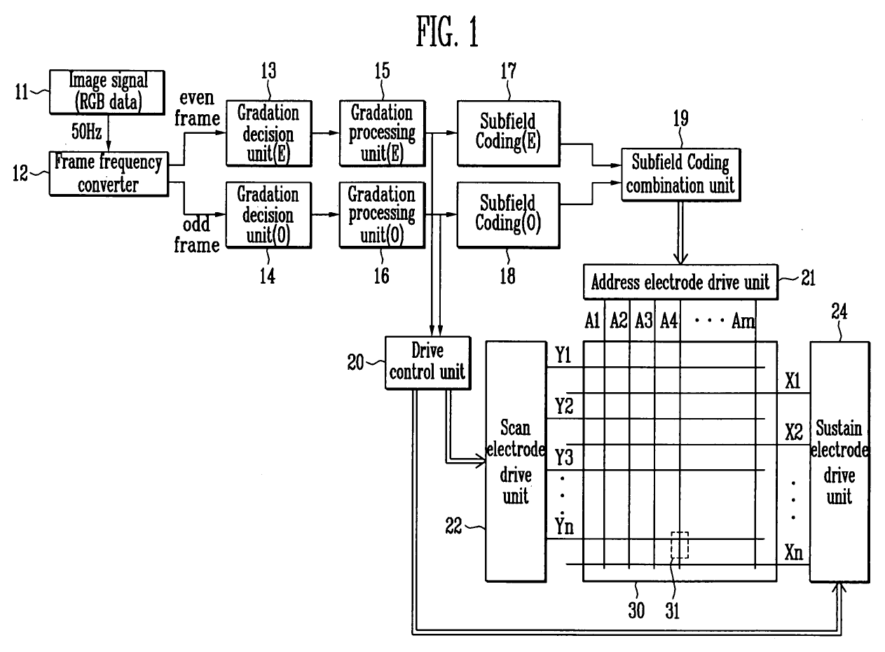

FIG. 1 is a block diagram of a plasma display device employing a driving method according to an embodiment of the present invention.

Referring to FIG. 1, a plasma display device according to an embodiment of the present invention includes a plasma display panel 30 and a driving apparatus to drive the display panel 30.

The display panel 30 includes a plurality of scan electrodes Y1, Y2, Y3 . . . Yn, a plurality of sustain electrodes X1, X2 . . . Xn, and a plurality of address electrodes A1, A2, A3, A4 . . . Am. Further the display panel 30 includes pixels 31 positioned at crossing regions of the aforementioned electrodes. The address electrodes A1, A2, A3, A4 . . . Am are coupled to an address electrode driver 21, the scan electrodes Y1, Y2, Y3 . . . Yn are coupled to a scan electrode driver 22, and the sustain electrodes X1, X2 . . . Xn are coupled to a sustain electrode driver 24.

The driving apparatus processes an image signal 11 input from the outside and supplies the processed image signal 11 to the display panel 30 to display the image corresponding to the image signal 11 on the display panel 30. The driving apparatus includes an image processor, a subfield controller, and a drive controller 20. The image processor includes a frame frequency converter 12, a first gradation decision unit 13, a second gradation decision unit 14, a first gradation processor 15 and a second gradation processor 16. The subfield controller includes a first subfield coding unit 17, a second subfield coding unit 18 and a subfield coding combiner 19. The address electrode driver 21, the scan electrode driver 22 and the sustain electrode driver 24 may be included in the drive controller 20.

The plasma display device according to an embodiment of the present invention has a technical characteristic that the frame frequency varies according to an input gradation (e.g., a gray level) of the image signal 11. That is, a plasma display device employing a driving apparatus according to an embodiment of the present invention has a technical characteristic that when the input gradation of an image signal is equal to or below a low gradation level at a specific gradation, 50 Hz and/or pseudo 100 Hz drives are mixedly performed, and when the input gradation exceeds the specific gradation, the drive is performed at a high frame frequency (e.g., 100 Hz). Elements of the driving apparatus according to an embodiment of the present invention are described in detail as follows.

The frame frequency converter 12 produces an even frame and an odd frame by converting an image signal containing RGB (red, green, blue) data twice. In an exemplary frame frequency converting method, a simple copying method and an interpolation may be used to produce the even frame and the odd frame. The produced even frame and odd frame may be shown individually as two subfield groups as shown in FIG. 2. That is, the even frame may be provided as first to sixth subfields sf1 to sf6, and the odd frame may be provided as seventh to thirteenth subfields sf7 to sf13.

The driving apparatus according to the embodiment of the present invention may receive an image signal of 100 Hz including an even frame and an odd frame as an original image signal input. Therefore, the frame frequency converter 12 may be omitted from the driving apparatus.

The first gradation decision unit 13 decides a gradation processing method for an even frame received from the frame frequency converter 12. Further, the first gradation decision unit 13 compares a gradation of the even frame with a reference level (e.g., a gradation level). When the gradation of the even frame is a low gradation that is equal to or below the reference level, 50 Hz or pseudo 100 Hz is selected as a display reference frequency to achieve a unit-light reduction and a dithering noise reduction. When the gradation of the even frame exceeds the reference level, a current frame frequency, e.g., 100 Hz, is selected as a display reference frequency. The second gradation decision unit 14 decides a gradation processing method for an odd frame received from the frame frequency converter 12 similarly to that of the first gradation decision unit 13.

In deciding the gradation processing method for the even and odd frames, the first and second gradation decision units 13 and 14 operate so that a gradation display reference frequency of one subfield having a minimum gradation of a frame and another subfield consecutive to the one subfield among the even frame and the odd frame becomes a half of a current frame frequency when a gradation of the image signal is equal to or below a reference level. Further, the first and second gradation decision units 13 and 14 operate so that a corresponding subfield of a frame having a minimum weighted value or minimum gradation and a corresponding subfield of a frame having a second-smallest gradation among the even frame and the odd frame have mutually different gradation display reference frequencies when a gradation of image signal is equal to or below a reference level. The mutually different gradation display reference frequencies are described in detail as follows.

The first gradation processor 15 performs a dithering for a gradation display on the basis of a gradation display reference frequency decided in the first gradation decision unit 13. The second gradation processor 16 performs a dithering for a gradation display on the basis of a gradation display reference frequency decided in the second gradation decision unit 14.

The first subfield coding unit 17 changes an even subfield received from the first gradation processor 15 into even subfield coding information. The second subfield coding unit 18 changes an odd subfield received from the second gradation processor 16 into odd subfield coding information.

The subfield coding combiner 19 combines the even frame information received from the first subfield coding unit 17 and the odd frame information received from the second subfield coding unit 18 into a frame frequency for driving the display panel. Here, the frame frequency may be 100 Hz or 120 Hz to obtain a high-quality image of high definition (HD). The frame frequency may be at 50 Hz or 60 Hz of course. The subfield coding combiner 19 applies the combined subfield information to the address electrode driver 21.

The drive controller 20 receives an even frame and an odd frame provided from the first and second gradation processors 15 and 16, respectively, and generates drive signals for the scan electrode driver 22 and the sustain electrode driver 24 by using received frame information. The driving controller 20 also transfers the generated drive signals to the scan electrode driver 22 and the sustain electrode driver 24.

For ease of describing the embodiments of the present invention, according to some embodiments, it is described that a first reference level includes a 1A reference level and a 1B reference level that is different from the 1A reference level. According to some other embodiments, it is described that an example of the 1A reference level is the same as the 1B reference level.

First, referring to FIG. 2, a method of driving a plasma display device according to a first embodiment is described in detail as follows. The embodiment is explained with an input image signal with a frame frequency of 50 Hz as an illustrative example.

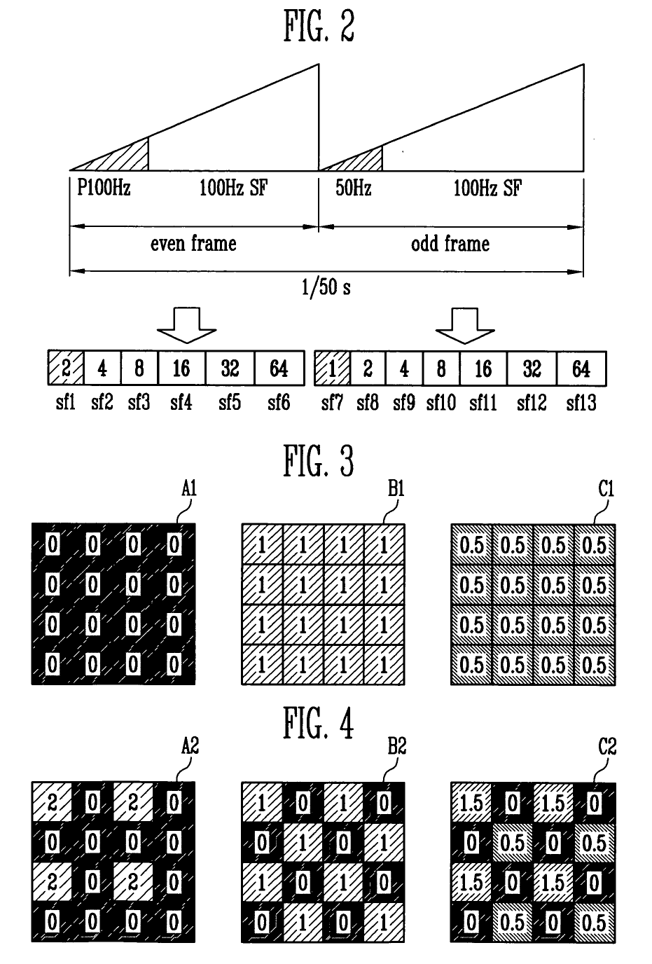

FIG. 2 illustrates a method of driving a plasma display device according to the first embodiment of the invention. FIG. 3 illustrates a dithering result in a plasma display driving method, and FIG. 4 illustrates a dithering result of a comparison example.

The driving method according to the first embodiment of the present invention provides two subfield groups for a unit frame of input image signal for 1/50 second. Here the two subfield groups are different from each other in the number of subfields and their weighted values.

In detail, as shown in FIG. 2, when a 100 Hz image is input, the frame frequency converter operates to independently display respective images for six subfields, i.e., first to sixth subfields sf1 to sf6 of an even frame section and seven subfields, i.e., seventh to thirteenth sf7 to sf13 of an odd frame section so as to realize a real 100 Hz drive. Here, to prevent dithering noise from becoming severe, that is, to improve a gradation display of the image, the image is displayed through a mixed use of 50 Hz drive and 100 Hz drive for a subfield used for a low gradation display of the image by using the gradation decision units 13 and 14 in the driving apparatus according to the first embodiment of the present invention.

For example, as shown in FIG. 3, a gradation of 0.5 can be displayed only with a smallest subfield of an odd frame B1 without using an even frame A1, thus it is displayed like the dithering result C1. In this case, the gradation can be displayed more smoothly since a unit-light becomes small.

On the other hand, with reference to FIG. 4, in displaying a gradation of 0.5 in a method of using the typical inverse gamma correction, an even frame A2 is displayed by dithering a gradation of 0 and a gradation of 2, and an odd frame B2 is displayed by dithering a gradation of 0 and a gradation of 1. That is, in displaying a gradation of 0.5, a light corresponding to the first subfield sf1 that is a minimum gradation of the even frame A2, and a light corresponding to the first subfield sf7 that is a minimum gradation of the odd frame B2, are used concurrently. Thus, a dithering result with lower image quality is provided in the image as shown in C2 of FIG. 4.

A subfield used for each gradation and a corresponding display gradation value in the first embodiment of the present invention may be represented as illustrated in the following tables 1 and 2. The tables 1 and 2 provide gradation display conditions using the subfield sf1 that is a minimum gradation of the even frame and the subfield sf7 that is a minimum gradation of the odd frame.

TABLE 1

| | Even frame | Odd frame | Used |
|---|---|---|---|
| Input gradation | gradation | gradation | subfield |
| 0 ≦ level ≦ sf7/2 | 0 | level × 2 | sf7 |
| sf7/2 < level ≦ | level × 2 − sf7 | sf7 | sf1, sf7 |
| (sf7 + sf1)/2 | | | |
| (sf7 + sf1)/2 < level | level | level | — |

The table 1 offers an example that the odd frame includes a subfield of minimum gradation. In other words, in the table 1, the seventh subfield sf7 of the odd frame has a minimum weighted value for a period of 1/50 seconds, and the first subfield sf1 of the even frame has a weighted value of a second-smallest value. Here, the ½ times of the seventh subfield sf7 becomes a 1A reference level, and ½ times of the sum of the seventh subfield sf7 and the first subfield sf1 becomes a 1B reference level.

As illustrated in the table 1, an input gradation of a 100 Hz image signal is converted twice into an even frame and an odd frame, and gradations of the even and odd frames are controlled independently and then combined, and are displayed as the gradation of the image signal. Here, in the driving method of the first embodiment, when an input gradation of the even frame is equal to or below the 1A reference level, the even frame is processed as a gradation of 0, and the odd frame is processed as the twice of the gradation, and then the input gradation is displayed as a mean of the two frames, that is, as one half of the seventh subfield sf7 of the odd frame.

Additionally, in the driving method of the first embodiment, when the input gradation exceeds the 1A reference level and is equal to or below the 1B reference level, the seventh subfield sf7 of the odd frame becomes on, and the rest of the brightness corresponding to the input gradation is provided in the even frame. That is, in such condition, the even frame is processed to provide a gradation level obtained by deducting a gradation level of the seventh subfield sf7 from twice the value of the input gradation level, and the odd frame is processed to provide a current gradation level of the seventh subfield sf7. Thus the input gradation is displayed as a mean gradation level of two subfields sf7 and sf1 of two frames.

Further, in the driving method according to the first embodiment of the invention, when the input gradation exceeds the 1B reference level, the input gradation is displayed as a mean of current gradation levels of the two frames.

TABLE 2

| | Even frame | Odd frame | Used |
|---|---|---|---|
| Input gradation | gradation | gradation | subfield |
| 0 ≦ level ≦ sf1/2 | level × 2 | 0 | sf1 |
| sf1/2 < level ≦ | sf1 | level × 2 − sf1 | sf1, sf7 |
| (sf1 + sf7)/2 | | | |
| (sf1 + sf7)/2 < level | level | level | — |

The table 2 provides an example where the even frame includes a subfield of the minimum gradation. In other words, in the table 2, the first subfield sf1 of the even frame has a minimum weighted value for a period of 1/50 seconds, and the seventh subfield sf7 of the odd frame has a weighted value of a second-smallest value. Here, the one half of the first subfield sf1 is a 1A reference level, and a mean of the first subfield sf1 and the seventh subfield sf7 is a 1B reference level.

As illustrated in the table 2, an input gradation of a 100 Hz image signal is converted twice into an even frame and an odd frame, and gradations of the even and odd frames are controlled independently and then combined, and are displayed as the gradation of image signal. Here, in the driving method of the embodiment, when an input gradation of the odd frame is equal to or below the 1A reference level, the odd frame is processed as a gradation of 0, and the even frame is processed as twice the input gradation. Then the input gradation is displayed as a mean of the two frames, that is, as one half of the first subfield sf1 of the even frame.

Furthermore, in the driving method of the first embodiment, when the input gradation exceeds the 1A reference level and is equal to or below the 1B reference level, the first subfield sf1 of the even frame becomes an on-state, and the rest of the brightness corresponding to the input gradation is provided in the odd frame. That is, in such condition, the odd frame is processed to provide a gradation level obtained by deducting a level of the first subfield sf1 from twice the input gradation level, and the even frame is processed as a current gradation level of the first subfield sf1. Thus, the input gradation is displayed as a mean gradation level of the two subfields sf1 and sf7 of two frames.

Further, in the driving method of the first embodiment, when the input gradation exceeds the 1B reference level, the input gradation is displayed as a mean of current gradation levels of the two frames.

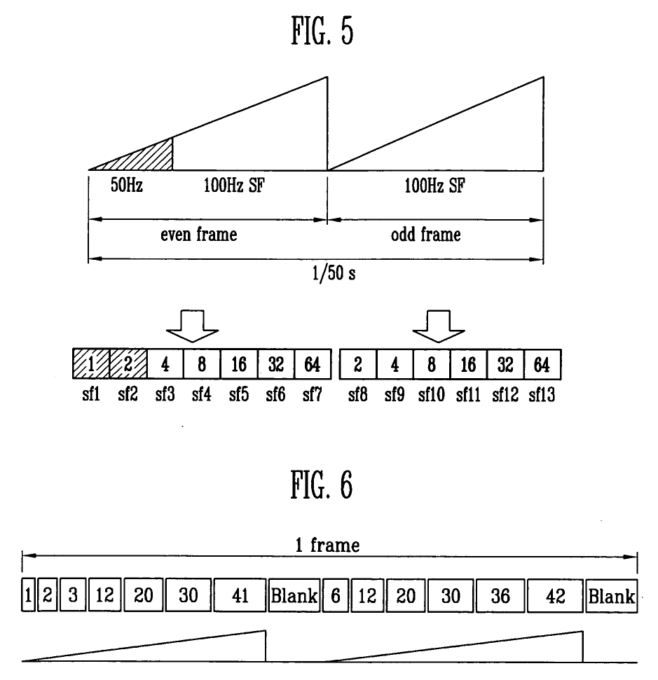

An example where the 1A reference level and the 1B reference level are the same is described as follows with reference to FIG. 5. FIG. 5 illustrates a method of driving a plasma display device according to a second embodiment of the present invention.

In the plasma display driving method according to the second embodiment of the present invention, a unit frame of an input image signal may be provided as two subfield groups for 1/50 second. Here the two subfield groups are different from each other in number of subfields and their weighted values. In particular, the driving method of the second embodiment has a main technical characteristic that among two subfield groups for a unit frame of the input image signal, a subfield having a minimum weighted value and its consecutive subfield in the subfield group having the minimum weighted value are driven at one half of the frame frequency of the rest of the subfields.

In detail, as shown in FIG. 5, in the plasma display driving method according to the second embodiment of the present invention, a 100 Hz image signal is converted twice into an even frame and an odd frame having mutually different gradations and weighted values when the 100 Hz image signal is input. Respective gradations for seven subfields, first to seventh subfields sf1 to sf7 of an even frame section, and six subfields, eighth to thirteenth subfields sf8 to sf13 of an odd frame section, are independently processed as a real 100 Hz drive. Here, to prevent dithering noise from becoming severe, that is, to improve a gradation display of the image signal, the driving method of the second embodiment has a characteristic that is different from the first embodiment that only two consecutive subfields used in a low gradation display are driven at one half of the frame frequency. Here, for example, one half of the frame frequency is 50 Hz.

Subfields used for each gradation and corresponding display gradation values in the second embodiment of the present invention may be represented as illustrated in the following table 3.

TABLE 3

| | Even frame | Odd frame | |
|---|---|---|---|
| Input gradation | gradation | gradation | Used subfield |
| 0 < level ≦ (sf1 + sf2)/2 | level × 2 | 0 | sf1, sf2 |
| (sf1 + sf2)/2 < level | level | level | — |

In the table 3, the first subfield sf1 has a minimum weighted value for a period of 1/50 second, and the second subfield sf2 is consecutive to the first subfield sf1. In this case, a mean of the first and second subfields sf1 and sf2 becomes a first reference level.

As illustrated in the table 3, in the driving method of the second embodiment, a 100 Hz input gradation is compared to the first reference level, and when the 100 Hz input gradation is equal to or below the first reference level, the gradation of the first subfield sf1 having a minimum weighted value of the even frame and the gradation of the second subfield sf2 consecutive to the first subfield sf1 are processed twice, and the odd frame is not used. Further, in the combination of even frame and odd frame, the gradation of the first subfield sf1 is displayed in average.

Further, in the driving method of the second embodiment, when the input gradation exceeds the first reference level, the input gradation is displayed by the corresponding subfields in an average of the combination of the two frames.

As described above, according to the described embodiments of the present invention, when an input gradation of an image signal is equal to or below a reference level, a subfield having a minimum weighted value is driven at one half of the frame frequency, and a subfield consecutive to the subfield having the minimum weighted value is driven at one half of the frame frequency, in subfields of two frames converted twice from the image signal or a subfield having a weighted value of a second-smallest value of a frame not including the minimum weighted value is processed in a pseudo frame frequency. Accordingly a gradation display of a plasma display device can be improved, and the plasma display device can be driven at a high frame frequency.

FIG. 6 illustrates a method of driving a plasma display device as a comparison example. The plasma display driving method illustrated in the comparison example uses a pseudo 100 Hz frame frequency.

As shown in FIG. 6, in the driving method of a pseudo frame frequency of 100 Hz, a first subfield with a weighted value of 1 and a second subfield with a weighted value of 2 in the left subfield group are illuminated, and in the right subfield group, a seventh subfield with a weighted value of 6 in the right subfield group is illuminated, in displaying a gradation of 9.

That is, the driving method of a pseudo frame frequency of 100 Hz is based on a plasma display driving method to divide a unit frame into two subfield groups and to display one gradation level by using the two subfield groups.

In such a pseudo 100 Hz driving method, a flicker is reduced as compared with a 50 Hz driving method, but it causes a dual phase on a moving image since there are two light axes. Furthermore, when two light focuses have a large difference in size, there still exists a flicker.

In a typical plasma display driving method like the comparison example described above, an image quality may be lowered when the plasma display is driven at a high frame frequency. However, in the driving device and method according to some embodiments of the present invention, a high frame frequency drive can be achieved without lowering an image quality of the plasma display device.

According to the embodiments of the present invention described above, using a 100 Hz drive frequency as an example, a subfield group having a minimum gradation among two subfield groups is driven at a frequency mix of 50 Hz and 100 Hz, and thus the gradation display is improved. However, the present invention is not limited to such configuration described above, for example, a 120 Hz drive can be used as the driving frequency. For example, in the 120 Hz drive, a subfield group having a minimum gradation among two subfield groups is driven at a frequency mix of 60 Hz and 120 Hz. Therefore, a plasma display device can be driven in a high frame frequency of 100 Hz or 120 Hz, thereby enhancing the gradation display.

While the present invention has been described in connection with certain exemplary embodiments, it is to be understood that the present invention is not limited to the disclosed embodiments, but, on the contrary, is intended to cover various modifications and equivalent arrangements included within the spirit and scope of the appended claims, and equivalents thereof.

What is claimed is:

1. A method of driving a plasma display device, the method comprising:
separating a unit frame of an input image signal into first and second subfield groups;
deciding a gradation of each of the first and second subfield groups; and
displaying the gradation in a first frame frequency when a minimum gradation level of the first or second subfield group is equal to or below a first reference level, and to display the gradation in a second frame frequency when the minimum gradation level exceeds the first reference level.

2. The method according to claim 1, wherein the first reference level is a mean of gradations of a first subfield and a second subfield that is consecutive to the first subfield, the first subfield having a minimum weighted value in a subfield group among the first and second subfield groups.

3. The method according to claim 2, wherein a number of subfields in the first subfield group is different from a number of subfield in the second subfield group.

4. The method according to claim 1, wherein the first reference level comprises a first reference level and a second reference level that is different from the first reference level, and
the method comprises deciding the gradation of each of the first and second subfield groups to display the gradation in the first frame frequency when the minimum gradation level of the first or second subfield group is equal to or below the first reference level, and to display the gradation in a pseudo second frame frequency when the minimum gradation level exceeds the first reference level and is equal to or below the second reference level, and to display the gradation in the second frame frequency when the minimum gradation level exceeds the second reference level.

5. The method according to claim 4, wherein the first reference level is one half of the minimum gradation level.

6. The method according to claim 5, wherein the second reference level is a mean of the minimum gradation levels of the first and second subfield groups.

7. The method according to claim 4, wherein a number of subfields in the first subfield group is different from a number of subfields in the second subfield group.

8. The method according to claim 4, wherein the first frame frequency is 50 Hz or 60 Hz.

9. The method according to claim 8, wherein the second frame frequency is 100 Hz or 120 Hz.

10. The method according to claim 1, further comprising individually dithering the first and second subfield groups on the decided gradation.

11. The method according to claim 10, further comprising individually coding the first and second subfield groups in accordance with the decided gradation.

12. The method according to claim 11, further comprising combining coding information of the first subfield group and coding information of the second subfield group and generating final subfield information of the unit frame, and transferring the generated final subfield information to an address electrode driver.

13. The method according to claim 12, further comprising generating a drive signal for the decided gradation of the first and second subfield groups, and transferring the generated drive signal to a scan electrode driver and a sustain electrode driver.

14. The method according to claim 1, further comprising converting twice a frame frequency of the input image signal.

15. An apparatus for driving a plasma display device comprising:
a frame frequency converter for separating a unit frame of an input image signal into first and second subfield groups; and
a gradation decision unit for deciding a gradation of each of the subfield groups to display the gradation in a first frame frequency when a minimum gradation level of the first or second subfield group transferred from the frame frequency converter is equal to or below a first reference level, and to display the gradation in a second frame frequency when the minimum gradation level is greater than the first reference level.

16. The apparatus according to claim 15, wherein the first reference level is a mean of gradations of a first subfield and a second subfield that is consecutive to the first subfield, the first subfield having a minimum weighted value in a subfield group among the first and second subfield groups.

17. The apparatus according to claim 16, wherein a number of subfields in the first subfield group is different from a number of subfield in the second subfield group.

18. The apparatus according to claim 15, wherein the first reference level comprises a 1A reference level and a 1B reference level, and
the gradation decision unit decides the gradation of each of the subfield groups to display the gradation in the first frame frequency when the minimum gradation level of the first or second subfield group transferred from the frequency converter is equal to or below the 1A reference level, and to display the gradation in a pseudo second frame frequency when the minimum gradation level exceeds the 1A reference level and is equal to or below the 1B reference level, and to display the gradation in the second frame frequency when the minimum gradation level exceeds the 1B reference level.

19. The apparatus according to claim 18, wherein the 1A reference level is one half of the minimum gradation level.

20. The apparatus according to claim 19, wherein the 1B reference level is a mean of two minimum gradation levels of the first and second subfield groups.

21. The apparatus according to claim 18, wherein a number of subfields in the first subfield group is different from a number of subfields in the second subfield group.

22. The apparatus according to claim 15, further comprising a gradation processor for individually dithering the first and second subfield groups for the gradation decided in the gradation decision unit.

23. The apparatus according to claim 22, further comprising a subfield coding unit for individually coding the first and second subfield groups received from the gradation processor.

24. The apparatus according to claim 23, further comprising a subfield coding combiner for combining coding information of the first subfield group and coding information of the second subfield group received from the subfield coding unit and generating final subfield information of the unit frame, and for transferring the generated final subfield information to an address electrode driver.

25. The apparatus according to claim 24, further comprising a drive controller for generating drive signals corresponding to the first and second subfield groups received from the gradation processor, transferring a portion of the generated drive signals to a scan electrode driver, and transferring another portion of the generated drive signals to a sustain electrode driver.

26. The apparatus according to claim 15, wherein the frame frequency converter converts twice a frame frequency of the input image signal.

27. The apparatus according to claim 18, wherein the first frame frequency is 50 Hz or 60 Hz, and the second frame frequency is 100 Hz or 120 Hz.
